(19) United States
(12) Patent Application Publication
(10) Pub. No.: US 2002/0185859 A1
(43) Pub. Date: Dec. 12, 2002

(54) Event planning guide and method of manufacturing the same

(76) Inventors: Barbara Reger, Redondo Beach, CA (US); Christine Boucher, Tarzana, CA (US)

Correspondence Address: CISLO & THOMAS, LLP, 233 WILSHIRE BLVD, SUITE 900, SANTA MONICA, CA, 90401-1211, US

(21) Appl. No.: 10/151,063

(22) Filed: May 17, 2002

Related U.S. Application Data
(60) Provisional application No. 60/292,164, filed on May 18, 2001.

(51) Int. Cl. B42D 15/00; B42D 3/00

(52) U.S. Cl. 283/106; 281/31

(57) ABSTRACT

An event planning guide comprises a compartmental accordion style folder encased in a matchbook style cover, used to house invitations, envelopes, booklets, and the like relating to an event such as a wedding, birthday party. A method for manufacturing the event planning guide from two individual sheets is also provided.

### CROSS-REFERENCES TO RELATED APPLICATIONS

This patent application is related to U.S. Provisional Application Serial Number 06/292,164 filed May 18, 2002 for EVENT PLANNING GUIDE AND METHOD OF MANUFACTURING THE SAME, which application is incorporated herein by this reference thereto.

### BACKGROUND OF THE INVENTION

1. Field of the Invention

This invention relates to an organizational tool and method of manufacturing the same for assisting an individual in planning and organizing events.

2. Description of the Related Art

Planning and organizing special events can be time consuming and stressful for an individual who desires to undertake such a task. Also, there can be great importance in the organization and planning of a special event, which will be especially true if it is an event to celebrate a special time for a loved one. For this reason, there are many books and other publications in the art on how to organize and plan events such as these.

Although these publications offer guidelines and checklists, there is an inordinate amount of detail that is needed when planning such special events. There are so many steps and intricacies necessary in planning these types of events and these publications do not present an easy to follow and organized system for planning such a complex event. The intricacies include theme decor, date selection, location, guests, menu, party favors and entertainment as well as intricacies within these individual categories. Much planning and organization can be needed for a special event to be successful.

Also, known in the art are planners and planning systems. Most of these planners and planning systems consist of loose leaf binders containing pre-printed forms and divider sheets with index tabs used to divide materials into different sections. These planners also come with storage space for pens, pencils, scissors and the like. The planning tools in the prior art do not address the specific time related necessities and do not create a simple schedule for the individual organizer.

Therefore, what is needed in the art is a unique looking event planning guide and method of manufacturing the same that will help organize and plan events by assisting an individual through the details and time related chores necessary to organize and plan a successful event.

### SUMMARY OF THE INVENTION

Starting with theme decor and continuing through choosing a date and location, organizing a guest list, sending out invitations, planning a menu, choosing party favors, selecting music to be played and concluding with hosting the party, the present invention and method of manufacturing the same comprises a new and improved event planning guide

The event planning guide comprises a compartmental accordion style folder encased in a matchbook style cover, used to house invitations, envelopes, booklets, and the like. Each event planning guide is unique to the specific type of event that is to be planned. The cover of the event planning guide may identify the event that is to be planned and the folder inside the cover may contain invitations, envelopes, an event planning booklet and other items relating to the event.

### OBJECTS OF THE INVENTION

It is an object of the present invention to provide an event planning guide comprising a compartmental accordion style folder encased in a matchbook style cover.

It is another object of the present invention to provide an event planning guide for organizing and storing items related to the event.

It is another object of the present invention to provide an event planning guide that will help organize and plan events by assisting an individual through the details and time related chores necessary to organize and plan a successful event.

It is another object of the present invention to provide a unique method of manufacturing of an event planning guide.

These and other objects and advantages of the present invention will be apparent from a review of the following specification and accompanying drawings.

### BRIEF DESCRIPTION OF THE DRAWINGS

FIG. 1 is a perspective view of the events planning guide present invention shown fully assembled and closed.

FIG. 2 is a perspective view of the events planning guide of FIG. 1 shown fully assembled and open.

FIG. 3 is a top view of the unassembled individual sheet of the interior folder of the events planning guide of FIG. 1.

FIG. 4 is a top view of the unassembled individual sheet of the cover of the events planning guide of FIG. 1.

FIG. 5 is a side view of the assembled individual sheet forming the interior folder of the events planning guide of FIG. 1.

FIG. 6 is a perspective view showing of the partial assembly of the events planning guide of FIG. 1.

FIG. 7 is a top view of a die cut shape in the center panel of the three pocket interior section of the present invention.

FIGS. 8a-g are examples of cards, which include tools to aid a person in planning an event.

### DESCRIPTION OF THE PREFERRED EMBODIMENTS

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

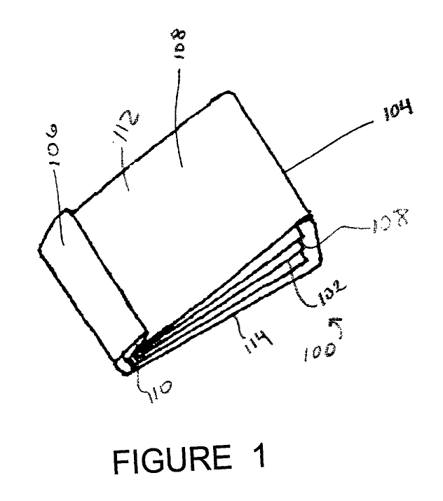

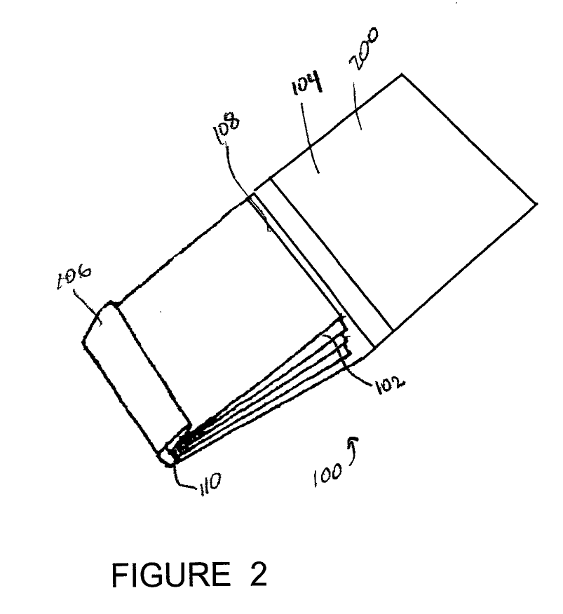

The events planning guide 100, shown in FIGS. 1 and 2, comprises a compartmental accordion style folder 102 forming the interior of the guide 100, and a matchbook style cover 104.

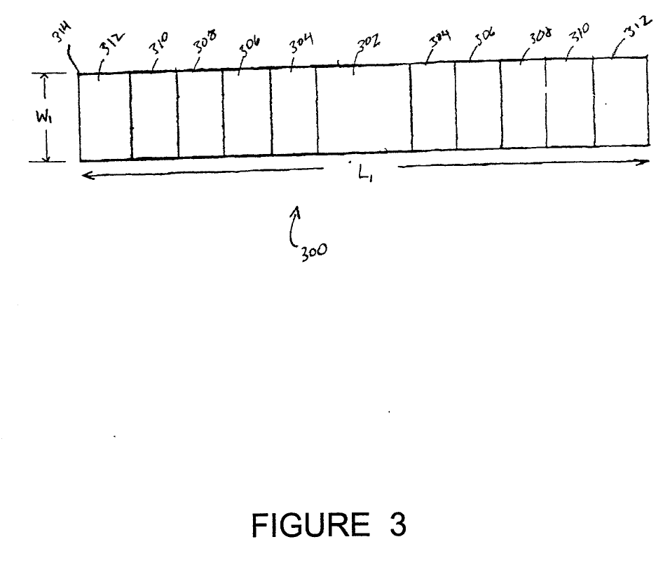

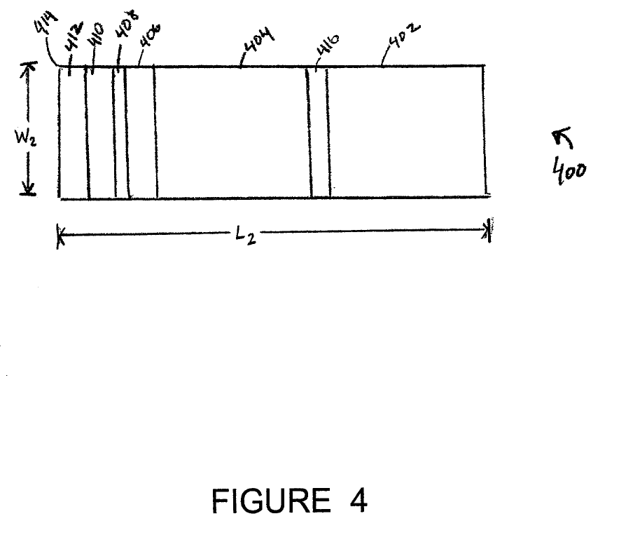

According to a preferred method of manufacture, the guide 100 is formed from two individual sheets. Shown in FIGS. 3 is a first individual sheet 300, having a length “L₁” and width “W₁”, which is used to form the interior folder 102. Shown in FIG. 4 is a second individual sheet 400, having a length “L2” and width “W2”, which is used to form the cover 104 of the guide.

In the preferred embodiment, the sheets 300 and 400 are made of poster board, or other material with similar properties such as paper or cardboard, however, any other suitable material may be used. Both sheets are preferably made of the same material, however, this need not be the case.

For manufacture of the events planning organizer, the first sheet 300, is folded or creased to create a plurality of rectangular divisions along the length of the sheet, comprising a central panel division 302, and a plurality of pairs of side divisions 304, 306, 308, 310, and 312. It is to be understood that the term rectangular as use herein also includes square. Although five pairs of side divisions are shown in FIG. 3, any number could be used in practice, with three pairs being a preferred minimum. According to the preferred embodiment, the side divisions of each pair are equal to each other, and are approximately half the length of the central panel, however, this need not necessarily be the case.

In the preferred embodiment of the present invention, the first sheet 300 measures 40 inches in length and 6½ inches in width. To prepare the first sheet 300 for assembly, a first reference point 314 is used. Folds or creases-are made at distances of 3¾ inches, 7 inches, 10½ inches, 13½ inches, 16¾ inches, 23¼ inches, 26½ inches, 29¾ inches, 33 inches and 36¼ inches from the first reference point 314 to create central panel 302, and 304, 306, 308, 310, and 312 of side divisions. According to these measurements, the end pair of divisions 312 is slightly longer then half the central panel length. This is for the purpose of overlapping each end of the pair as will be described below. Additionally, the other pairs of side division 304, 306, 308, and 310 are made half the length of the central panel 302; however, they may also be made shorter.

Additional variations of the measurements of the folds or creases of the first sheet 300 can also be made without departing from the inventive concept of the present invention. In the preferred embodiment, sheet 300 is folded symmetrically and therefore the measurement for the folds or creases can instead be made from the opposite end 316 of the first reference point 314.

The second individual sheet 400 that is used for the cover 104 of the present invention, and is folded or creased to create front and back cover divisions 402, 404, and several smaller divisions 406, 408, 410, 412, and 416.

In the preferred embodiment, the second sheet 400 measures 15 9/16″×6½″. To prepare the sheet 400 for assembly, a reference point 414 is used. Folds or creases are made at distances of 15/16″, 1 15/16″, 2 3/16″, 3 3/16″, 8 13/16″ and 9 7/16″ from the reference point 414. Different variations of the measurements of the folds or creases of the second individual sheet 400 can also be made without departing from the inventive concept of the present invention.

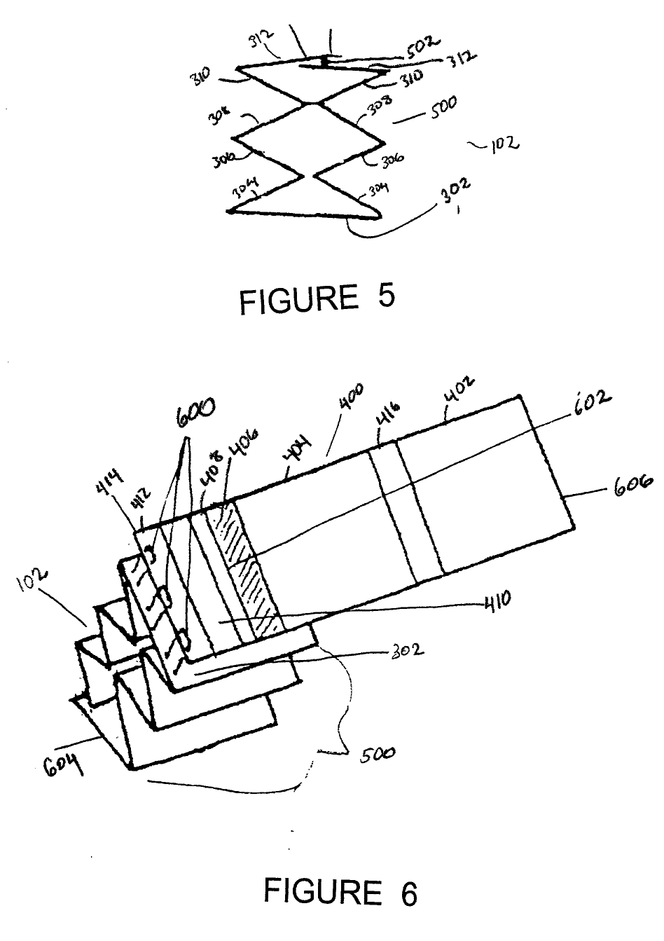

FIGS. 5 and 6, with reference to FIGS. 3 and 4, show accordion style folds 500 made from each fold or crease on both sides of the center panel 302 of the first sheet 300 and the assembly of the first sheet 300 and the second sheet 400. In the preferred embodiment, double sided tape 502 is placed in the area where the ends of the pair 312 overlap, forming the assembled interior folder 102. Other adhesives with similar properties may also be used to create this assembly, such as glue or other styles of tape. This creates an accordion style folder having three pockets which are used for placement of invitations, envelopes and the like, according to the preferred embodiment. It is possible, however, that dimensions can be altered and more or less than three pockets can be used.

The attachment of the assembled interior folder 102 and the second individual sheet 400 is made by aligning the reference point 414 of sheet 400 with one end of the center panel 302 of the assembled first sheet 300, as shown in FIG. 6, and attaching the two together, preferably by stitching. In the preferred embodiment, three separate stitching areas 600 are used, but many different styles or amount of stitches can be used in the present invention.

Once the stitching is completed, double sided tape as used in the preferred embodiment, or any similar adhesive is placed on the division 406 of the second sheet 400. Next, the division 410 of the second sheet 400 is folded over the stitching areas 600 such that the bottom 602 of the division 406 wraps around the accordion style folds 500 and aligns with the bottom 604 of the assembled first sheet 300. The second sheet 400 is further wrapped around the first sheet 300, such that when completed the end 606 of the sheet 400 can be tucked underneath the lip 106 that is created by the sheet 400, as shown in FIG. 1. Thus, an accordion style folder 102 having an open end 108 and a closed end 110 is formed.

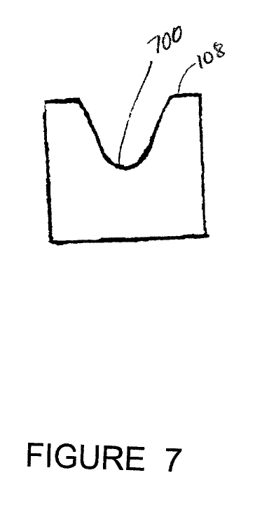

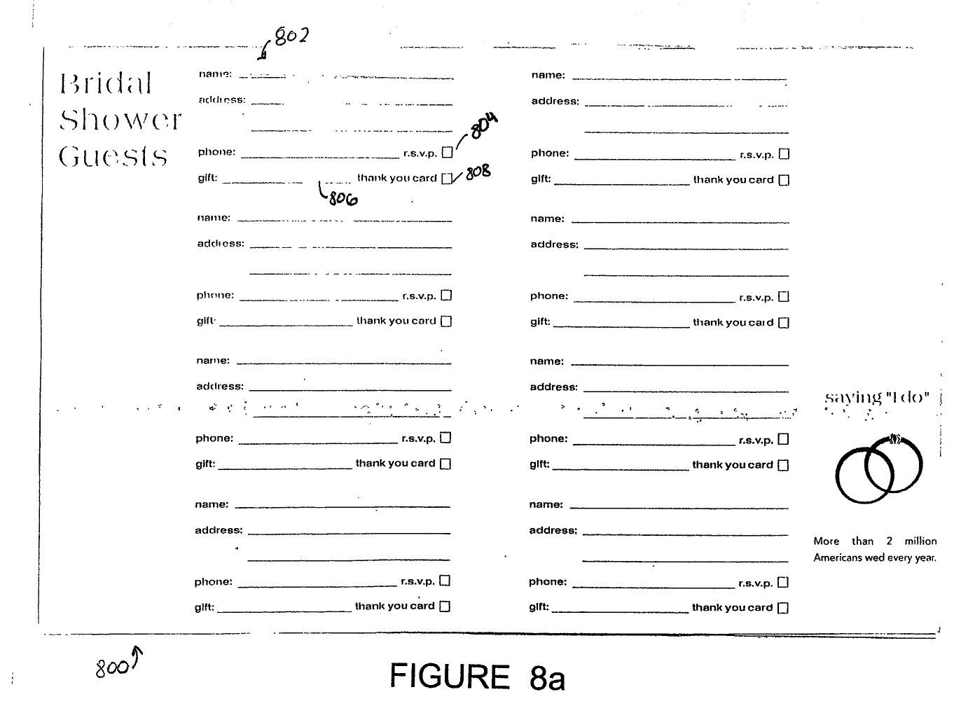

FIG. 7 shows an optional die cut 700 that can be made along the open end 108 of the folder 102. Although any type of cut is not required, other types of cut out designs can also be used with the present invention.

Referring back to FIG. 1, a particular design can be placed on the front and back sides 112 and 114 of the cover 104 of the guide 100. Designs can also be placed on the lip 106 or on any other areas of the guide 100, such as the undercover 200, shown in FIG. 2. The designs may include textual and pictorial graphics such as illustrations and photography.

The events planning guide 100 can include different designs and information depending upon what type of event is being organized and planned. Various events which may be planned using the guide 100 include, but are not limited to, baby showers, bridal showers, weddings, birthday parties, bachelor parties, sweet sixteens, bar mitzvah's, and graduation parties.

Each individual event planning guide may include a booklet that can be located inside a pocket of the folder 102. The booklet may provide background information on the type of event or celebration being planned and gives advice on location, day and time of event, who and how many guests, theme decor, menu, party favors, suggestions for entertainment/games and other informational tools. Other items, such as invitations and envelopes may be included in another pocket of the folder, for a folder having multiple pockets.

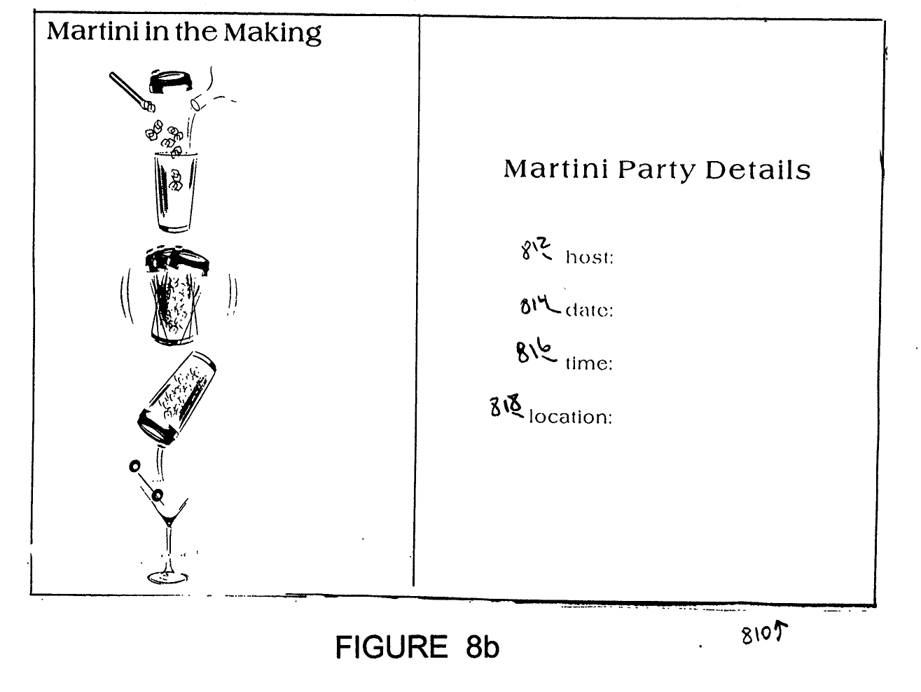

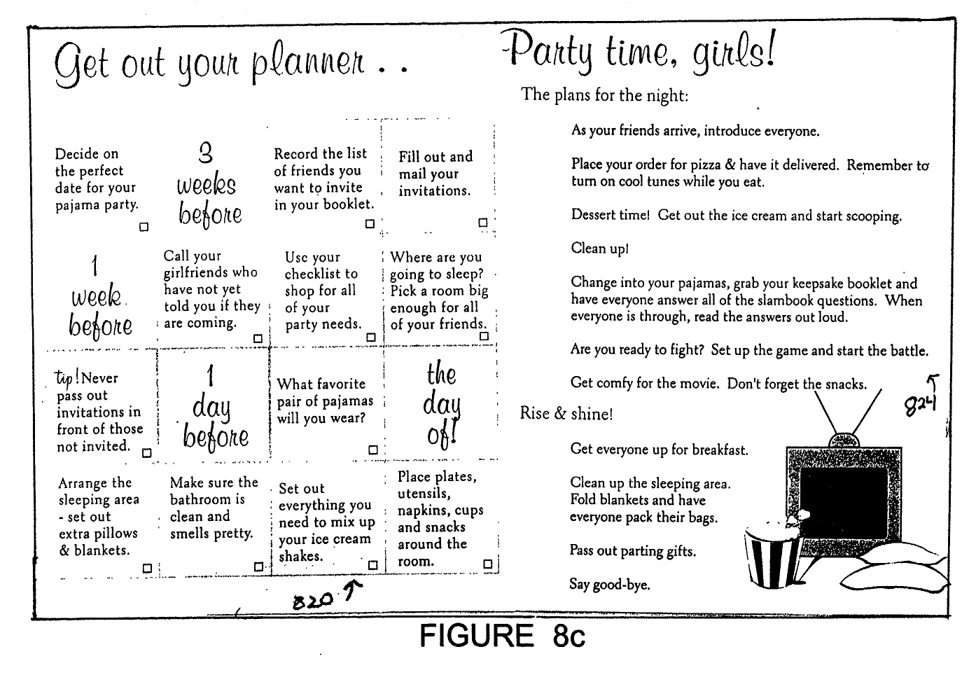

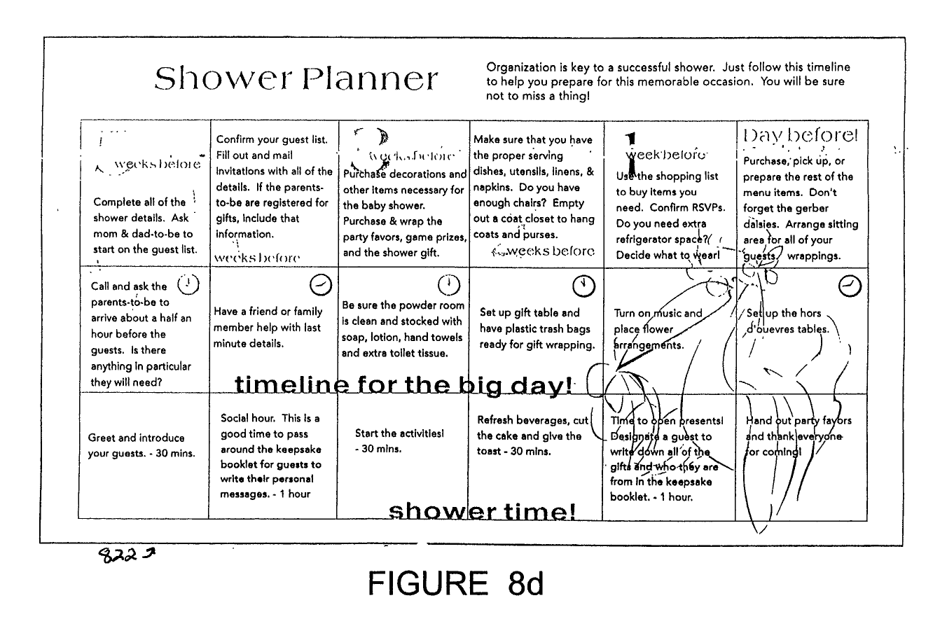

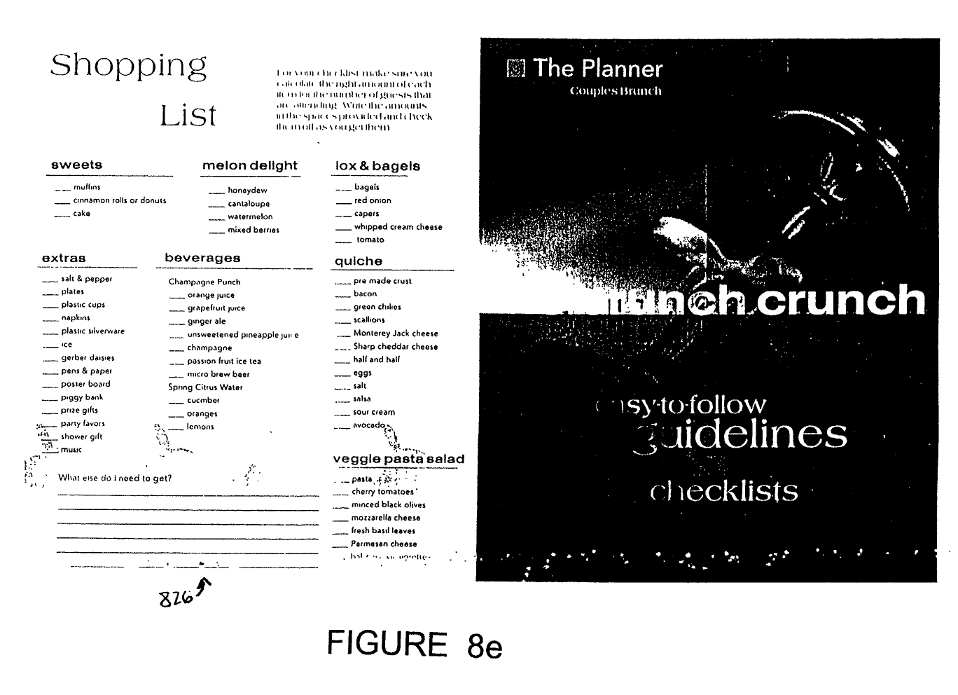

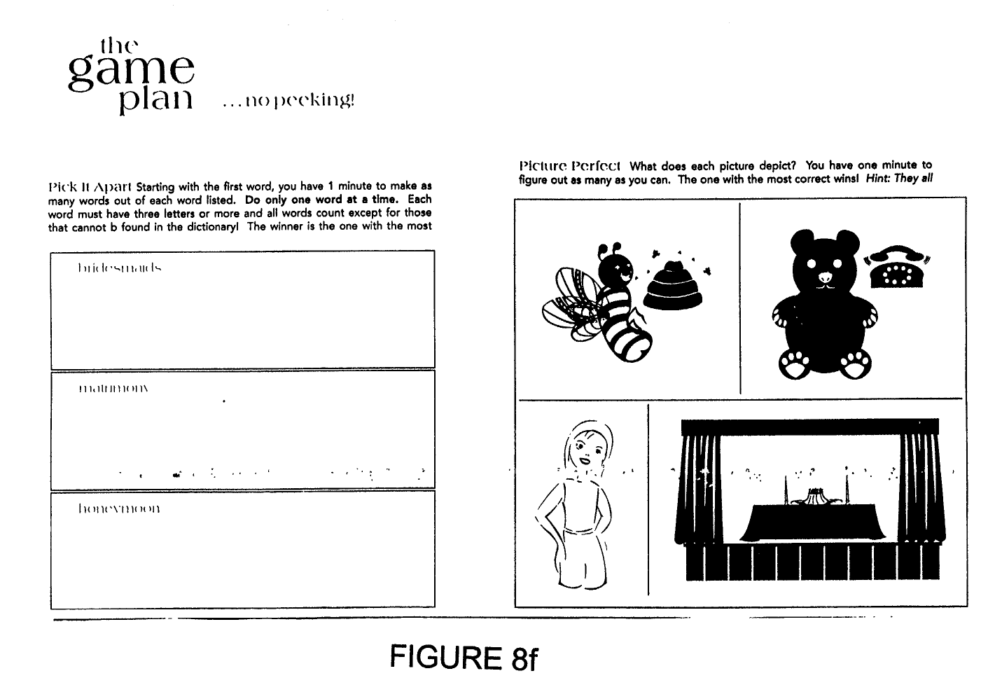

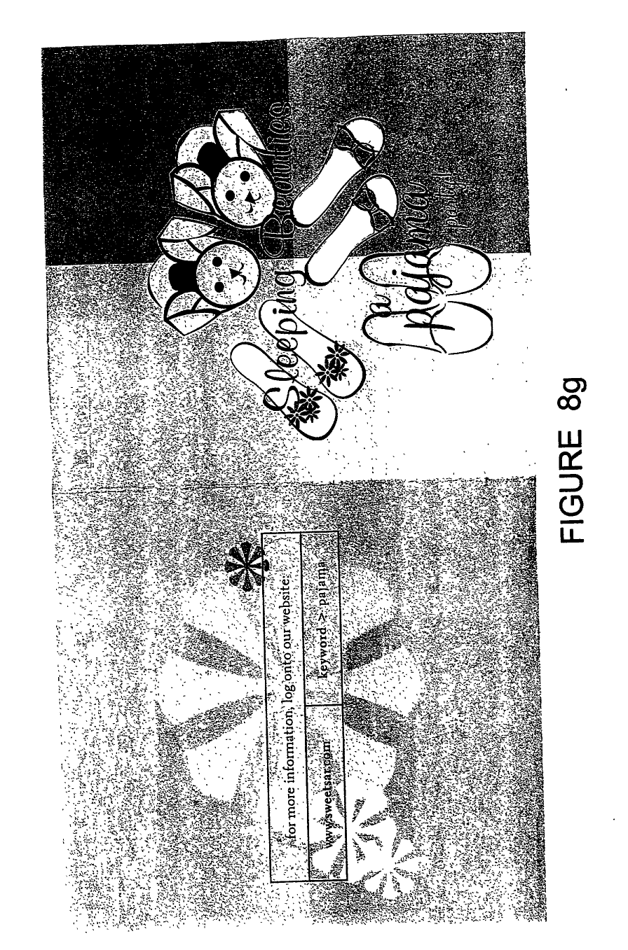

According to a preferred embodiment, cards (shown in FIGS. 8a-d), which include informational tools to aid a person in planning a party, may be included in the pockets of the folder or in the booklet. The cards are preferably designed especially for the specific event, and may include artwork relating to the event.

A party guest list 800, as shown in FIG. 8a, may provide spaces 802 for the name of each guest, boxes 804 for checking off as guests reply, space 806 for noting a gift received, and a checkbox 808 for indicating whether a thank you note was sent.

A list 810 for recording event information, as shown in FIG. 8b, may provide space for listing the host 812, date 814, time 816, and location 818 of the event. Other information such as the guest of honor, and the date the invitations were sent, may also be provided. This can allow the individual planning the event to keep track of all of the relevant needs for the event itself.

Different timelines 820, 822, as shown in FIGS. 8c and d, can be provided in order to assist the individual in keeping the planning for the event and the event itself organized. A Timeline can provide a list of chores to be completed at certain times before the event date. Examples of chores include deciding on location, sending invitations, ordering the cake, cleaning the party location, shopping and picking up the cake and food.

An event activities timeline 824, as shown in FIG. 8c, for assisting in scheduling party activities such as reception, hors d'oeuvres, introductions, games, opening of gifts, cake and coffee, etc., may also be provided.

Other tools in assisting the event planning may include a shopping list 826 of menu suggestions and a menu guide, as shown in FIG. 8e. This can assist the individual in determining what type and what quantity of food to buy for the specific event. The list 826 can provide different choices for drinks, appetizers, entrees and desserts, depending upon what type of event is being organized. Suggestions for how much food and drinks to buy, depending on the number of guests, may also be provided.

Other event planning tools may include entertainment suggestions, as shown in FIG. 8f. Types of appropriate games and game instructions can be listed in relation to the specific event that is taking place. Suggestions for appropriate music selections to represent the mood of the event can be made as well.

If the individual organizer feels that they need more information, additional resources which may be helpful in planning the event, as shown in FIG. 8g, may also be provided.

The totality of the information located in the event planning booklet can make the planning of the event, the organizing of the event and the event itself much less stressful for the organizer and possibly help them host an unforgettable event for a loved one or friend.

With respect to the above description, it is to be realized that the optimum dimensional relationships for the parts of the invention, to include variations in size, materials, shape, form, function and manner if operation, assembly and use, are deemed readily apparent and obvious to one skilled in the art, and all equivalent relationships to those illustrated in the drawings and described in the specification are intended to be encompassed by the present invention.

What is claimed is:

1. An event planning guide comprising:
a folder including at least one pocket for retaining items, said pocket having an open end; and
a matchbook style cover attached to said folder, wherein
the planning guide may be in an opened or closed configuration, wherein in said closed configuration said cover encloses said open end for retaining said items, and wherein in said open configuration, said open end is uncovered such that said items can be placed into or removed from said pocket.

2. The guide of claim 1 wherein said folder is accordion style.

3. The guide of claim 1 wherein said folder includes three pockets.

4. The guide of claim 1 wherein said items contained in said folder include sheets containing event planning tools.

5. The guide of claim 4, said event planning tools comprising information relating to the event, a guest list, an event planning timeline, an event activities timeline, menu suggestions, a menu guide, invitations, envelopes, entertainment suggestions, a list of resources, or a combination thereof.

6. The guide of claim 1, wherein the event to be planned is a bridal shower, baby shower, wedding, birthday party, bachelor party, sweet sixteen, bar mitzvah, or a graduation party.

7. The guide of claim 1 wherein said cover includes designs relating to the event.

8. The guide of claim 1 wherein said open end of said pocket includes a die cut along its edge.

9. A device for retaining items comprising:
an accordion style folder including a plurality of pockets, said pockets having open ends; and
a matchbook style cover attached to said folder, wherein
the planning guide may be in an opened or closed configuration, wherein in said closed configuration said cover encloses said open ends for retaining the items, and wherein in said open configuration, said open ends are uncovered such that the items can be placed into or removed from said pockets.

10. A method of manufacturing an event planning guide comprising:
creasing a first sheet along its length to create a central panel division, and a plurality of side divisions forming pairs on the left and right sides of said central panel, said side divisions being smaller then said central panel division;
forming a folder from said first sheet, said folder having accordion style folds formed from said pairs on the sides of said central panel, and an end panel formed opposite said central panel by joining the pair of side divisions furthest from said central panel division, said folder having two open ends opposite one another;
creasing a second sheet along its length to create front and back cover divisions, and a plurality of side cover divisions, said side cover divisions being smaller than said front and back cover divisions;
attaching said second sheet to said folder formed from said first sheet, and wrapping said second sheet around said folder such that said second sheet forms a matchbook style cover retaining said folder and sealing one of said two open ends of said folder, wherein
the guide may be in an open configuration for placing items in said folder by inserting items through the other of said two open ends, and in a closed configuration for retaining items placed in the folder.

11. The method of claim 10, said folder including a plurality of pockets.

12. The method of claim 11 wherein said first sheet is creased to create five pairs of side divisions, and wherein said folder has three pockets.

13. The method of claim 10 wherein said second sheet is creased to create five side cover divisions.

14. The method of claim 10, further- comprising the step of forming a die cut along the other of said two open ends.

15. The method of claim 10 wherein said second sheet is attached to said folder formed from said first sheet by stitching a first end of said second sheet to the central panel of said first sheet, said first end forming one of the side cover divisions of the second sheet.

16. The method of claim 15 wherein said first end of said second sheet and an adjacent side cover division form a lip of said matchbook style cover, wherein the second end of said second sheet end can be tucked underneath said lip for placing the guide in said closed configuration, said second end being opposite said first end and forming said back cover division of said second sheet.

17. An event planning guide comprising:
folder means including at least one pocket means for retaining items, said pocket means having an open end; and
a matchbook style cover means attached to said folder means, wherein
the planning guide may be in an opened or closed configuration, wherein in said closed configuration said cover means encloses said open end for retaining said items, and wherein in said open configuration, said open end is uncovered such that said items can be placed into or removed from said pocket means.

18. A method of manufacturing an event planning guide comprising:
forming folder means from said first sheet by creasing a first sheet along its length to create a central panel division, and a plurality of side divisions forming pairs on the left and right sides of said central panel, said side divisions being smaller then said central panel division,
said folder means having accordion style folds formed from said pairs on the sides of said central panel, and an end panel formed opposite said central panel by joining the pair of side divisions furthest from said central panel division, said folder means having two open ends opposite one another; and
forming a matchbook style cover means for retaining said folder and sealing one of said two open ends of said folder by:
creasing a second sheet along its length to create front and back cover divisions, and a plurality of side cover divisions, said side cover divisions being smaller than said front and back cover divisions; and
attaching said second sheet to said folder means formed from said first sheet, and wrapping said second sheet around said folder means such that said second sheet, wherein
the guide may be in an open configuration for placing items in said folder means by inserting items through the other of said two open ends, and in a closed configuration for retaining items placed in said folder means.
